(19) United States
(12) Patent Application Publication
(10) Pub. No.: US 2013/0229600 A1
(43) Pub. Date: Sep. 5, 2013

(54) DISPLAY DEVICE, ELECTRONIC APPARATUS AND BONDING STRUCTURE

(71) Applicant: JAPAN DISPLAY WEST, INC., Aichi-Ken (JP)

(72) Inventors: Daisuke Takama, Kanagawa (JP); Takeo Koito, Kanagawa (JP)

(73) Assignee: JAPAN DISPLAY WEST, INC., Aichi-Ken (JP)

(21) Appl. No.: 13/763,074

(22) Filed: Feb. 8, 2013

(30) Foreign Application Priority Data
Mar. 2, 2012 (JP) 2012-046793

(51) Int. Cl. G02F 1/1347; B32B 3/30

(52) U.S. Cl. CPC G02F 1/1347; B32B 3/30
USPC 349/77; 428/172

(57) ABSTRACT

A display device includes: a first display unit having a first terminal substrate corresponding to a display area and a terminal area protruding from the display area as well as a first counter substrate corresponding to the display area; and a second display unit having a second terminal substrate corresponding to the display area and the terminal area as well as a second counter substrate corresponding to the display area, wherein both the first display unit and the second display unit are bonded with each other so that the first terminal substrate and the second terminal substrate are positioned on opposite sides of a bonding surface.

### FIELD

The present disclosure relates to a display device, an electronic apparatus and a bonding structure.

### BACKGROUND

A technique in which light is spatially separated by using a parallax barrier, a lenticular lens and the like, and an image displayed on a display portion is divided into plural viewpoint images to be presented to an observer is known. The technique is used for, for example, a 3D display device presenting images with a parallax given to the right and left eyes of the observer, a directional display device displaying different images in accordance with the observation direction and other devices.

In the above technology, a part of spatially dividing light (hereinafter referred to as a light separation portion) can be electrically generated. For example, there is disclosed a technology in JP-A-3-119889 (Patent Document 1) in which stripes of transmissive portions and light-shielding portions of a parallax barrier are generated by using a transmissive liquid crystal display. In the technology, two liquid crystal displays respectively functioning as the display portion and as the parallax barrier are bonded with each other, for example, as shown FIG. 9 in Patent Document 1.

### SUMMARY

In recent years, the display device is becoming high definition. When the definition of the above-described 3D display device and the directional display device is increased, for example, the image is divided into viewpoint images with a thinner width. In this case, a pitch of the barrier in the parallax barrier and a lens diameter of the lenticular lens are further decreased. Accordingly, it is necessary to narrow the distance between the light separation portion (the parallax barrier, the lenticular lens and so on) and the display portion in the display device.

That is, when the light separation portion is electrically generated as described in Patent Document 1, the distance between function surfaces of two display units which function as the display portion and the parallax barrier respectively is shortened. However, a technology for shortening the distance between the function surfaces of the display units described above has not been sufficiently developed.

In view of the above, it is desirable to provide a novel and improved display device, an electronic apparatus and a bonding structure capable of shortening the distance between function surfaces of plural units to be bonded while maintaining functionality of substrates.

An embodiment of the present disclosure is directed to a display device including a first display unit having a first terminal substrate corresponding to a display area and a terminal area protruding from the display area as well as a first counter substrate corresponding to the display area, and a second display unit having a second terminal substrate corresponding to the display area and the terminal area as well as a second counter substrate corresponding to the display area, in which both the first display unit and the second display unit are bonded with each other so that the first terminal substrate and the second terminal substrate are positioned on opposite sides of a bonding surface.

Another embodiment of the present disclosure is directed to an electronic apparatus including a display device having a first display unit having a first terminal substrate corresponding to a display area and a terminal area protruding from the display area as well as a first counter substrate corresponding to the display area, and a second display unit having a second terminal substrate corresponding to the display area and the terminal area as well as a second counter substrate corresponding to the display area, in which both the first display unit and the second display unit are bonded with each other so that the first terminal substrate and the second terminal substrate are positioned on opposite sides of a bonding surface.

Still another embodiment of the present disclosure is directed to a bonding structure including a first unit having a first terminal substrate corresponding to a function area and a terminal area protruding from the function area as well as a first counter substrate corresponding to the function area, and a second unit having a second terminal substrate corresponding to the function area and the terminal area as well as a second counter substrate corresponding to the function area, which are bonded to each other so that both the first unit and the second unit are positioned on opposite sides of a bonding surface.

As the terminal substrates having the terminal area protruding from the function area are arranged on opposite sides of the bonding surface in respective unit to be bonded with each other, it is not always necessary to reduce the thickness of the terminal substrate when shortening the distance between function surfaces of units. Accordingly, it is possible to shorten the distance between the function surfaces while securing the strength of the terminal substrates. Also when circuit components are formed on the terminal substrate, a clearance between the terminal substrates can be sufficiently secured.

As described above, according to the embodiments of the present disclosure, the distance between the function surfaces of plural units to be bonded can be shortened while maintaining functionality of substrates.

### BRIEF DESCRIPTION OF THE DRAWINGS

FIG. 1 is a view showing a schematic structure of a display device;

FIG. 2 is a view showing a display device in which the thickness of substrates is not reduced;

FIG. 3 is a view showing a first trial example of reducing the thickness of the substrates in the display device shown in FIG. 2;

FIG. 4 is a view showing a second trial example of reducing the thickness of the substrates in the display device shown in FIG. 2;

FIG. 5 is a view showing a first example of a display device according to an embodiment of the present disclosure;

FIG. 6 is a view showing a second example of the display device according to the embodiment of the present disclosure;

FIG. 7 is a view showing a third example of the display device according to the embodiment of the present disclosure; and

FIG. 8 is a schematic block diagram showing a configuration of an electronic apparatus according to an embodiment of the present disclosure.

### DETAILED DESCRIPTION

Hereinafter, preferred embodiments of the present disclosure will be explained in detail with reference to the attached drawings. In the present specification and the drawings, the same symbols are given to the components having substantially the same functions and structures to thereby omit repeated explanation.

The explanation will be made in the following order.

1. Structure Example of Display Device

2. Trial Example For Reducing Thickness of Substrate

3. Embodiment of Present Disclosure

4. Other Embodiments of Present Disclosure

5. Supplement

### 1. Structure Example of Display Device

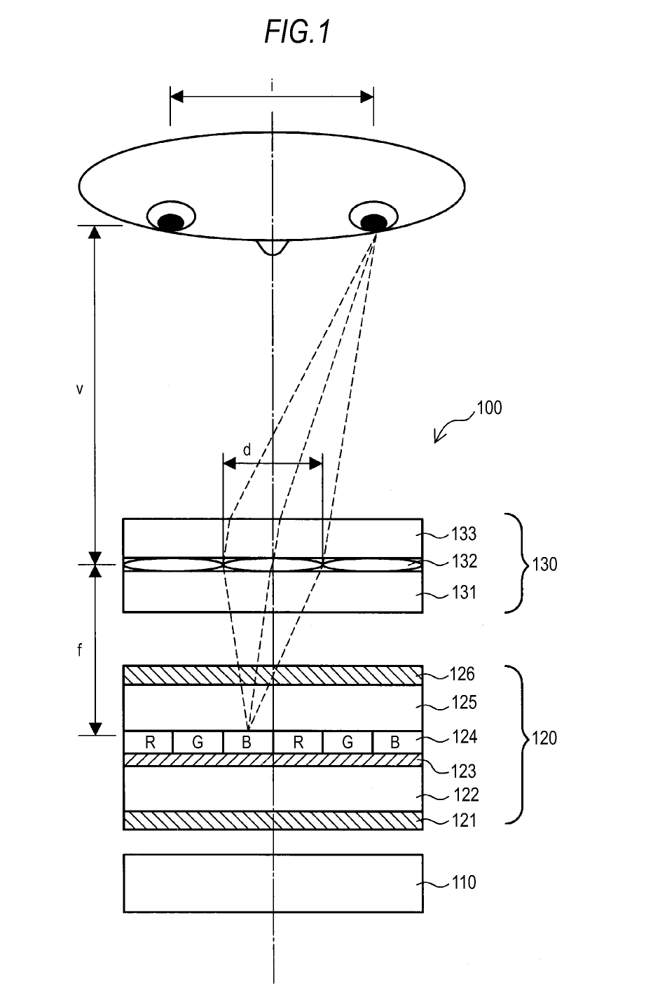

A structure example of a display device will be explained with reference to FIG. 1.

FIG. 1 is a view showing a schematic structure of a display device. Referring to FIG. 1, a display device 100 includes a backlight 110, an LCD (Liquid Crystal Display) 120 and a liquid crystal lens 130. The display device 100 is a 3D display device presenting viewpoint images with a parallax to the right and left eyes of an observer. The structure of the display device 100 can be easily applied to, for example, a directional display device presenting different viewpoint images to plural observers at different positions respectively. That is, an embodiment relating to the directional display device can be also realized in the same manner as the embodiment relating to the 3D display device explained below.

The backlight 110 is a light source portion irradiating light to the LCD 120. In the backlight 110, for example, a cold cathode fluorescent lamp (CCFL), a light emitting diode (LED) or the like is used as a light emitting device.

The LCD 120 includes polarizing plates 121 and 126, a terminal substrate 122, a liquid crystal layer 123, color filters 124 and a counter substrate 125. TFTs (thin-film transistors) and transparent pixel electrodes are arranged on the terminal substrate 122, applying voltages to the liquid crystal layer 123 existing between the terminal substrate 122 and the color filters 124 on which a transparent common electrode is formed. The LCD 120 controls light transmission from the backlight in units of respective areas corresponding to respective colors arranged in the color filters 124 and controls light emission of respective colors included in the pixel to thereby display color images.

The liquid crystal lens 130 includes a terminal substrate 131, a liquid crystal layer 132 and a counter substrate 133. Transparent electrodes arranged on the terminal substrate 131 apply voltages to the liquid crystal 132 existing between the terminal substrate 131 and the counter electrode 133 on which transparent electrodes are arranged, which changes a refractive index of light in the liquid crystal layer 132 in units of areas. Accordingly, a lens effect which is equivalently the same as a lenticular lens occurs in the liquid crystal layer 132, and the image displayed on the LCD 120 is divided into two viewpoint images for displaying a 3D image.

### (Relation Between Lens Diameter and Focal Length)

The relation between a lens diameter “d” and a focal length “f” in the display device 100 explained above will be explained continuously with reference to FIG. 1. As described above, when the definition of the 3D display device is increased, the image is divided into viewpoint images with a thinner width. Therefore, the lens diameter “d” of a lens equivalently realized by the liquid crystal lens 130 (hereinafter also referred to as merely a lens) is further decreased when the definition of the display device 100 is increased.

On the other hand, the focal length “f” of the lens is determined by the lens diameter “d”, a preferred viewing distance “v” from the lens to the observer and an interocular distance “i” of the observer. If the preferred viewing distance “v” and the interocular distance “i” are fixed regardless of the lens diameter “d”, the focal length “f” is shortened as the lens diameter “d” is decreased. As an example, the focal distance “f” is 700 μm when the lens diameter “d” is 200 μm, whereas, the focal length “f” is approximately 500 μm when the lens diameter “d” is 140 μm. Accordingly, when increasing the definition of the display device 100, the focal distance “f” is decreased as the lens diameter “d” is decreased.

The display device 100 is designed so that a focal point of the lens equivalently realized by the liquid crystal lens 130 almost corresponds to a display surface of the LCD 120. That is, the display device 100 is designed so that a distance from a surface (hereinafter also referred to as a lens function surface of the liquid crystal lens 130) on which a principal point of the lens equivalently realized by the liquid crystal lens 130 is positioned to the display surface of the LCD 120 is almost equal to the focal length “f”.

Here, the lens function surface corresponds to the liquid crystal layer 132 of the liquid crystal lens 130. That is, the lens function surface is positioned between the terminal substrate 131 and the counter substrate 133. The display surface corresponds to the liquid crystal layer 123 or the color filters 124 of the LCD 120. That is, the display surface is positioned between the terminal substrate 122 and the counter substrate 125. Therefore, as the focal length “f” is shortened when the definition of the display device 100 is increased, it is necessary to shorten the distance between the lens function surface and the display surface by reducing the thickness of one or both of the counter substrate 125 and the terminal substrate 131 interposing between the lens function surface and the display surface.

The structure of the display device 100 has been explained mainly about functions of respective components as the above. Hereinafter, display devices 200 to 600 in which the arrangement of substrates differs from the display device 100 will be explained, and the functions of respective components are the same also in these display devices.

### 2. Trial Example for Reducing Thickness of Substrate

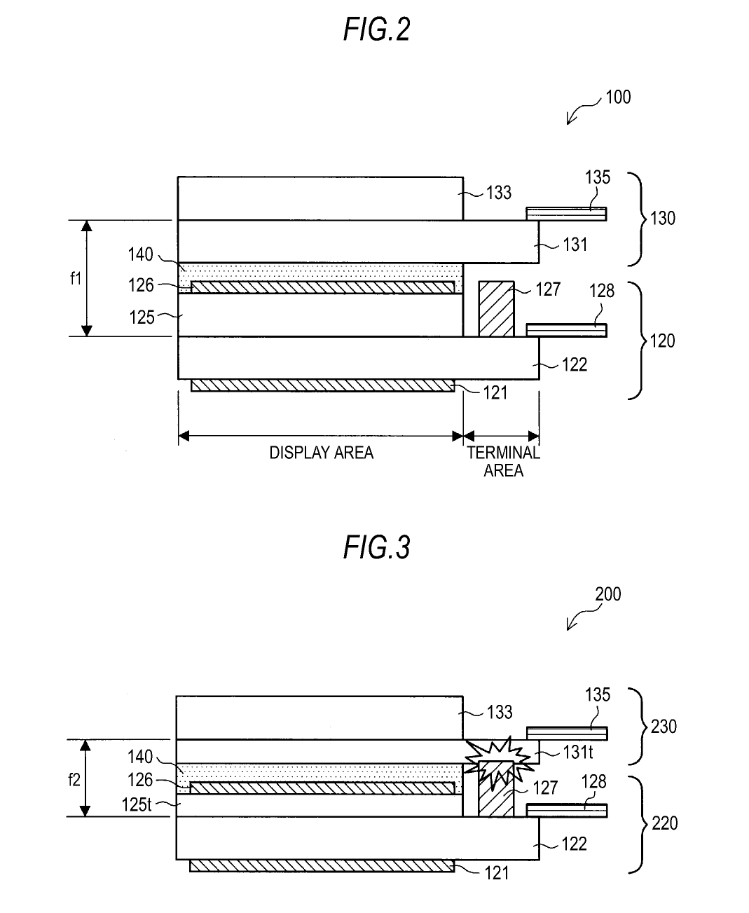

Subsequently, an example of trying out the thickness reduction of substrates in the display device will be explained with reference to FIG. 2 to FIG. 4.

(State in which Thickness Reduction is not Performed)

FIG. 2 is a view showing a display device in which thickness reduction of substrates is not performed. In FIG. 2, the display device 100 explained with reference to FIG. 1 is shown. FIG. 1 is the view showing part of a display area of the display device 100, while FIG. 2 is a view showing the entire display device 100. In FIG. 2, the backlight 110 is not shown.

Concerning the LCD 120, the polarizing plates 121 and 126, the terminal substrate 122, and the counter substrate 125 are shown. As a point not shown in FIG. 1, the terminal substrate 122 corresponds to a display area of the display device 100 and a terminal area protruding from the display area. On a terminal area portion of the terminal substrate 122, a driver IC (Integrated Circuit) 127 is provided. A flexible wiring 128 which transmits image signals to the driver IC 127 is connected to the terminal area portion of the terminal substrate 122. On the other hand, the counter substrate 125 corresponds to the display area and does not protrude to the terminal area.

Here, the display area does not necessarily indicate only an effective pixel portion but includes, for example, a peripheral area such as a bonded portion. The terminal area is an area in which circuit components, wiring and so on are provided on the substrate outside the display area, as described later. For example, when the display area is a rectangle, the terminal area may be provided so as to protrude from plural edges thereof.

Concerning the liquid crystal lens 130, the terminal substrate 131 and the counter substrate 133 are shown. As a point not shown in FIG. 1, the terminal substrate 131 corresponds to the display area of the display device 100 and the terminal area protruding from the display area. On a terminal area portion of the terminal substrate 131, a driver IC can be provided. A flexible wiring 135 which transmits a signal of refractive-index distribution pattern and so on to the driver IC is connected to the terminal area portion of the terminal substrate 131. On the other hand, the counter substrate 133 corresponds to the display area and does not protrude to the terminal area.

The above-described LCD 120 and the liquid crystal lens 130 are bonded to each other through, for example, a resin layer 140. In this case, a distance “f1” from the lens function surface of the liquid crystal lens 130 to the display surface of the LCD 120 is approximately the same as the sum of the thickness of two substrates (in the example of FIG. 2, the counter substrate 125 and the terminal substrate 131) positioned on the bonding surface's side in the LCD 120 and the liquid crystal lens 130 respectively, and the thickness of the resin layer 140. As the thickness of the resin layer 140 is thinner than the thickness of the substrates, the thickness of the above two substrates largely affects the distance “f1”.

Accordingly, when the focal length “f” of the lens equivalently realized by the liquid crystal lens 130 by increasing the definition of the display device 100, it is necessary to reduce the thickness of the two substrates positioned on the bonding surface's side in the LCD 120 and the liquid crystal lens 130 respectively (in the example of FIG. 2, the counter substrate 125 and the terminal substrate 131) for shortening the distance “f1” to be close to the focal distance “f”.

### (Trial to Reduce the Thickness-1)

As respective substrates included in the LCD 120 and the liquid crystal lens 130 are made of transparent materials such as glass or plastic, it is not necessarily difficult to reduce the thickness. Accordingly, it can be considered that the two substrates positioned on the bonding surface's side in the LCD 120 and the liquid crystal lens 130 respectively in the example of FIG. 2, namely, the counter substrate 125 and the terminal substrate 131 are reduced in thickness.

FIG. 3 is a view showing a first trial example of reducing the thickness of the substrates in the display device shown in FIG. 2. In the display device 200, an LCD 220 includes a counter substrate 125t the thickness of which is reduced and a liquid crystal lens 230 includes a terminal substrate 131t the thickness of which is reduced based on the above-described concept. Accordingly, the distance from the lens function surface to the display surface is shortened from the distance “f1” (thickness of normal two substrates+the resin layer) to a distance “f2” (thickness of two thinned substrates+the resin layer).

However, as a clearance between the terminal substrate 122 of the LCD 220 and the terminal substrate 131t of the liquid crystal lens 230 is narrowed in this case, the drive IC 127 provided on the terminal area portion of the terminal substrate 122 may touch the terminal substrate 131t. On the other hand, the strength of the terminal substrate 131t is reduced due to the thickness reduction though the terminal substrate 131t protrudes outside the display area as compared with the counter substrate 133, the terminal substrate 131t may be broken by the above-described touch and so on. Accordingly, it is not necessarily practical to reduce the thickness of the substrates such as in the example shown in FIG. 3.

In the following description, substrates shown by symbols ending in a character “t” represent substrates thicknesses of which are reduced and which have the same function as substrates shown by symbols to which the character “t” is not added. For simplification, respective substrates thicknesses of which are reduced (shown by symbols 122t, 125t, 131t and 133t) and respective substrates the thicknesses of which are not reduced (shown by symbols 122, 125, 131 and 133) respectively have approximately the same thickness. The actual thicknesses differ in respective substrates.

### (Trial to Reduce the Thickness-2)

In the above first example, the problem at the time of reducing the thickness is that the driver IC 127 provided on the terminal area portion of the terminal substrate 122 touches the terminal substrate 131t. It can be considered that the problem is solved by, for example, preventing the driver IC 127 from facing the liquid crystal lens 230.

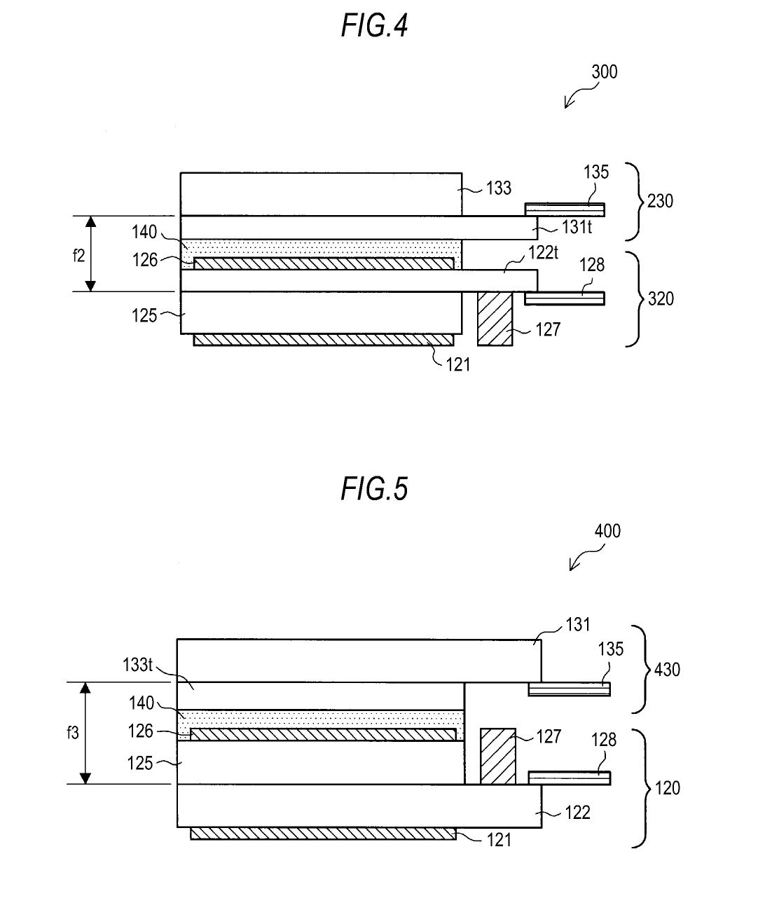

FIG. 4 is a view showing a second trial example of reducing the thickness of the substrates in the display device shown in FIG. 2. In a display device 300, the LCD is vertically inverted to be an LCD 320, and the thickness of the terminal substrate 122 accordingly positioned on the bonding surface's side is reduced to be a terminal substrate 122t based on the above-described concept. On the other hand, the liquid crystal lens 230 which is the same as the first example includes the terminal substrate 131t the thickness of which is reduced. Accordingly, the distance from the lens function surface to the display surface is shortened to the distance “f2” (thickness of two thinned substrates+the resin layer), which is the same as the first example.

However, in this case, as the terminal substrate 122t is positioned on the front side (observer's side) in the LCD 320, light reflection due to wiring such as TFTs arranged on the terminal substrate 122t occurs and visibility of an image to be displayed by the LCD 320 is reduced, though the problem due to the touch of the driver IC 127 does not occur. The reduction in strength of the terminal substrate 131t is the same as the first example. Therefore, there is still the possibility that the terminal substrate 131t is broken due to some other shocks. Accordingly, the thickness reduction of the substrates shown in FIG. 4 is not necessarily practical.

### 3. Embodiment of Present Disclosure

Subsequently, an example of reducing substrates according to the embodiment of the present disclosure will be explained referring to FIGS. 5 to 7.

### First Example

FIG. 5 is a view showing a first example of a display device according to the embodiment of the present disclosure. In a display device 400, the liquid crystal lens 130 is vertically inverted to be an liquid crystal lens 430, and the thickness of the terminal substrate 133 accordingly positioned on the bonding surface's side is reduced to be a terminal substrate 133t. On the other hand, the LCD 120 has the same structure as the one shown in the example shown in FIG. 2, which is not particularly reduced in thickness. Accordingly, the distance from the lens function surface to the display surface is reduced to a distance “f3” (thickness of one normal substrate+one thinned substrate+the resin layer) from the distance “f1” (thickness of normal two substrates+the resin layer) (distance “f3”>distance “f2”).

In the above example, as the liquid crystal lens 130 is vertically inverted to be the liquid crystal lens 430, the terminal substrate 131 is positioned on the opposite side of the bonding surface. Additionally, the thickness of the counter substrate 125 of the LCD 120 is not reduced and maintains the same thickness as in the case of FIG. 2. Therefore, a sufficient clearance is secured between the terminal substrate 122 of the LCD 120 and the terminal substrate 131 of the liquid crystal lens 430, and the possibility that the driver IC 127 provide on the terminal area portion of the terminal substrate 122 touches the terminal substrate 131 is low. Furthermore, as the thickness of the terminal substrate 131 is not reduced, the strength is maintained and the possibility of damage is relatively low even when some shocks are added.

### Second Example

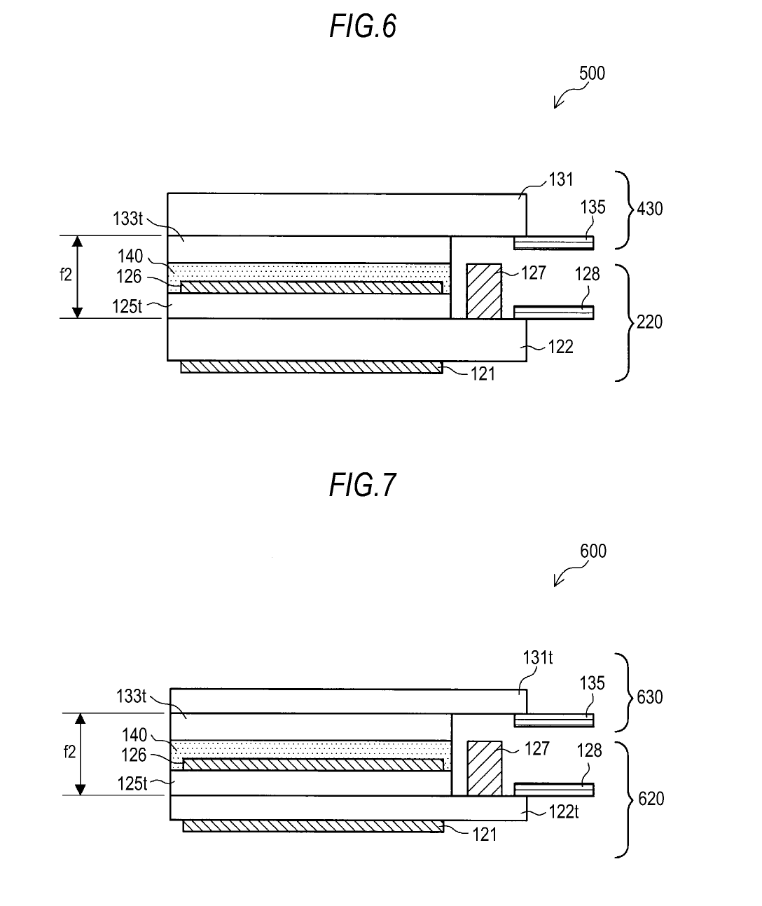

FIG. 6 is a view showing a second example of the display device according to the embodiment of the present disclosure. In a display device 500, the liquid crystal lens 130 is vertically inverted to be a liquid crystal lens 430, and the thickness of the terminal substrate 133 is reduced to be a terminal substrate 133t in the same manner as the first embodiment. Furthermore, the LCD 220 includes a counter substrate 125t the thickness of which is reduced. Accordingly, the distance from the lens function surface to the display surface is further reduced to the distance “f2” (thickness of two thinned substrates+the resin layer).

In the above example, as the counter substrate 125t of the LCD 220 is reduced in addition to the counter substrate 133t of the liquid crystal lens 430, the distance between the terminal substrate 122 of the LCD 220 and the terminal substrate 131 of the liquid crystal lens 430 is shortened as compared with the first embodiment. However, as the liquid crystal lens 430 is vertically inverted and the terminal substrate 131 is positioned on the opposite side of the bonding surface, the distance between the terminal substrate 122 and the terminal substrate 131 is still longer than the case of FIG. 2. Therefore, it is also possible to select any of the first example and the second example and to set a necessary sufficient clearance between the terminal substrate 122 and the terminal substrate 131 according to the size of the driver IC 127 provided on the terminal area portion of the terminal substrate 122.

### Third Example

FIG. 7 is a view showing a third example of the display device according to the embodiment of the present disclosure. In a display device 600, the liquid crystal lens 130 is vertically inverted to be a liquid crystal lens 630 in the same manner as the first and second embodiments. The liquid crystal lens 630 includes the terminal substrate 131t and the counter substrate 133t the thicknesses of which are both reduced. Additionally, the LCD 620 includes the terminal substrate 122t and the counter substrate 125t the thicknesses of which are both reduced. Accordingly, the distance from the lens function surface to the display surface is further reduced to the distance “f2” (thickness of two thinned substrates+the resin layer) in the same manner as the second embodiment, and the thickness of the entire display device is further reduced.

The above example is the same as the second embodiment in the point of shortening the distance between the lens function surface and the display device. It is possible to further realize the thickness reduction of the entire display device. It is not always necessary that the thicknesses of respective substrates are uniformly reduced, and for example, the thicknesses of the terminal substrate 122t and the terminal substrate 131t may be reduced in a range in which necessary strength can be secured.

### Brief of Embodiment

The examples of the thickness reduction of the substrates according to the embodiment have been explained as the above. As a point common to these examples, the LCD and the liquid crystal lens are bonded with each other so that terminal substrates thereof are positioned on the opposite sides of the bonding surface. Accordingly, for example, it is possible to prevent interference between circuit components such as the driver IC provided on the terminal substrate of the LCD and the terminal substrate of the liquid crystal lens. Additionally, as respective counter substrates of the LCD and the liquid crystal lens are positioned on the bonding surface's side, the thicknesses of respective counter substrates can be reduced for shortening the distance between the lens function surface and the display surface. Therefore, it is not always necessary to reduce the thickness of the terminal substrate having the terminal area protruding from the display area, and it is easy to secure necessary strength for such substrate. The thickness of the terminal substrate may be reduced if possible such as in the third example.

### 4. Other Embodiments of Present Disclosure

In the above embodiment, the structure of bonding the LCD and the liquid crystal lens in the display device has been explained, however, the embodiment of the present disclosure is not limited to the above. For example, also in the case where the parallax barrier is used as the light separation portion in the 3D display device or the directional display device, the pitch of the barrier is decreased by increasing the definition of the display device, as a result, it is necessary to shorten the distance between a barrier function surface (a surface on which barrier transmissive portions and light shielding portions are displayed such as in the liquid crystal display) and the display surface of the LCD. Also in this case, it is possible to shorten the distance between the barrier function surface and the display surface by applying the bonding structure according to the embodiment of the present disclosure.

The application range of the embodiment of the present disclosure is not limited to the display device using the above liquid crystal display. The display unit is not limited to the liquid crystal display as long as the display unit includes the terminal substrate and the counter substrate. The embodiment of the present disclosure can be effective when arbitrary units having the terminal substrate and the counter substrate are bonded with each other in addition to the case of the display unit.

### (Electronic Apparatus)

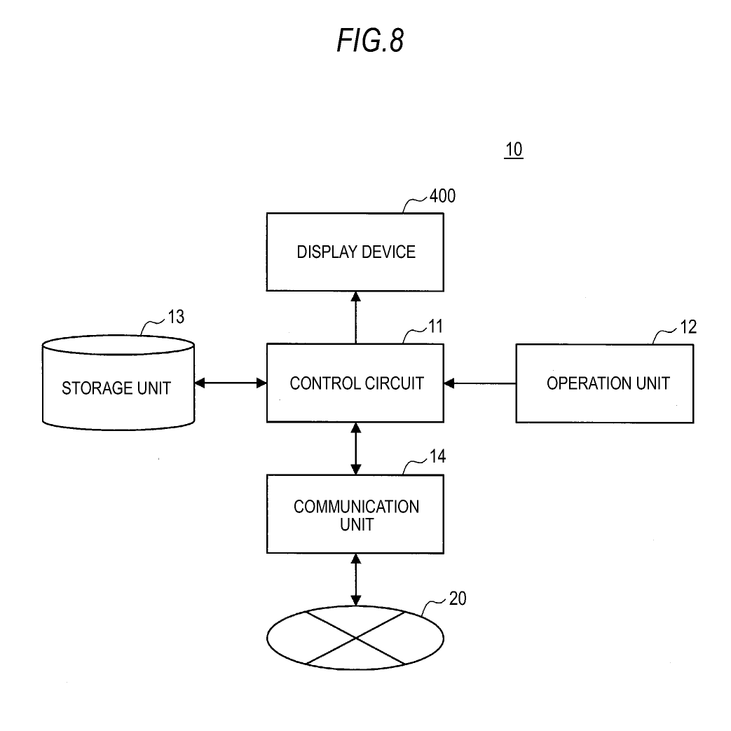

FIG. 8 is a schematic block diagram showing a configuration of an electronic apparatus according to an embodiment of the present disclosure. The display devices explained in respective embodiments can be incorporated in the electronic apparatus. The electronic apparatus is included in the embodiment of the present disclosure.

Referring to FIG. 8, an electronic apparatus 10 includes the display device 400, a control circuit 11, an operation unit 12, a storage unit 13 and a communication unit 14. The electronic apparatus 10 is any of apparatuses including the display device 400 as the display portion, such as a television, a cellular phone (smart phone), a digital camera, a personal computer and so on.

The control circuit 11 includes, for example, CPU (central processing unit), a RAM (random access memory), a ROM (read only memory) and so on, controlling respective units of the electronic apparatus 10. The display device 400 is also controlled by the control circuit 11.

The operation unit 12 includes, for example, a touch pad, buttons, a keyboard, a mouse or the like, receiving operation input with respect to the electronic apparatus 10 by a user. The control circuit 11 controls the electronic apparatus 10 in accordance with the operation input acquired by the operation unit 12.

The storage unit 13 includes, for example, a semiconductor memory, a magnetic disc, an optical disc or the like, storing various data necessary for allowing the electronic apparatus 10 to function. The control circuit 11 may be operated by reading a program stored in the storage unit 13 and executing the program.

The communication unit 14 is provided as an additional unit. The communication unit 14 is a communication interface connected to a wired or wireless network 20, including, for example, a modem, a port, an antenna or the like. The control circuit 11 receives data from the network 20 as well as transmits data to the network 20 through the communication unit 14.

The configuration of electronic apparatus 10 has been explained as described above. Though the display device 400 is incorporated in the electronic apparatus 10, the display devices 500 and 600 can also be incorporated in the electronic apparatus 10 in the same manner.

### 5. Supplement

The preferred embodiments of the present disclosure have been explained in detail with reference to the attached drawings as the above, however, the technical scope of the present disclosure is not limited to these embodiments. It is obvious that various alternations and modifications may occur to those skilled in the technical field of the present disclosure within the scope of technical ideas described in the appended claims, which naturally belong to the technical ideas of the present disclosure.

The following configurations also belong to the technical scope of the present disclosure.

(1) A display device including

a first display unit having a first terminal substrate corresponding to a display area and a terminal area protruding from the display area as well as a first counter substrate corresponding to the display area, and

a second display unit having a second terminal substrate corresponding to the display area and the terminal area as well as a second counter substrate corresponding to the display area,

in which both the first display unit and the second display unit are bonded with each other so that the first terminal substrate and the second terminal substrate are positioned on opposite sides of a bonding surface.

(2) The display device described in the above (1),

in which the first terminal substrate has circuit components on a bonding surface's side at a portion corresponding to the terminal area.

(3) The display device described in the above (2),

in which the first display unit functions as a display portion displaying an image, and

the second display unit functions as a light separation portion dividing the image displayed on the display portion by spatially separating light.

(4) The display device described in the above (3),

in which the first display unit is an LCD (Liquid Crystal Display).

(5) The display device described in the above (3) or (4),

in which the second display unit is a liquid crystal lens.

(6) The display device described in the above (3) or (4),

in which the second display unit is a parallax barrier.

(7) The display device described in any of the above (1) to (6),

in which the first counter substrate is thinner than the first terminal substrate.

(8) The display device described in any of the above (1) to (7),

in which the second counter substrate is thinner than the second terminal substrate.

(9) An electronic apparatus including

a display device having

a first display unit having a first terminal substrate corresponding to a display area and a terminal area protruding from the display area as well as a first counter substrate corresponding to the display area, and

a second display unit having a second terminal substrate corresponding to the display area and the terminal area as well as a second counter substrate corresponding to the display area,

in which both the first display unit and the second display unit are bonded with each other so that the first terminal substrate and the second terminal substrate are positioned on opposite sides of a bonding surface.

(10) A bonding structure including

a first unit having a first terminal substrate corresponding to a function area and a terminal area protruding from the function area as well as a first counter substrate corresponding to the function area, and

a second unit having a second terminal substrate corresponding to the function area and the terminal area as well as a second counter substrate corresponding to the function area, which are bonded to each other so that both the first unit and the second unit are positioned on opposite sides of a bonding surface.

The present disclosure contains subject matter related to that disclosed in Japanese Priority Patent Application JP 2012-046793 filed in the Japan Patent Office on Mar. 2, 2012, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display device comprising:
a first display unit having a first terminal substrate corresponding to a display area and a terminal area protruding from the display area as well as a first counter substrate corresponding to the display area; and
a second display unit having a second terminal substrate corresponding to the display area and the terminal area as well as a second counter substrate corresponding to the display area,
wherein both the first display unit and the second display unit are bonded with each other so that the first terminal substrate and the second terminal substrate are positioned on opposite sides of a bonding surface.

2. The display device according to claim 1,
wherein the first terminal substrate has circuit components on a bonding surface's side at a portion corresponding to the terminal area.

3. The display device according to claim 2,
wherein the first display unit functions as a display portion displaying an image, and
the second display unit functions as a light separation portion dividing the image displayed on the display portion by spatially separating light.

4. The display device according to claim 3,
wherein the first display unit is an LCD (Liquid Crystal Display).

5. The display device according to claim 3,
wherein the second display unit is a liquid crystal lens.

6. The display device according to claim 3,
wherein the second display unit is a parallax barrier.

7. The display device according to claim 1,
wherein the first counter substrate is thinner than the first terminal substrate.

8. The display device according to claim 1,
wherein the second counter substrate is thinner than the second terminal substrate.

9. An electronic apparatus comprising:
a display device having
a first display unit having a first terminal substrate corresponding to a display area and a terminal area protruding from the display area as well as a first counter substrate corresponding to the display area, and
a second display unit having a second terminal substrate corresponding to the display area and the terminal area as well as a second counter substrate corresponding to the display area,
in which both the first display unit and the second display unit are bonded with each other so that the first terminal substrate and the second terminal substrate are positioned on opposite sides of a bonding surface.

10. A bonding structure comprising:
a first unit having a first terminal substrate corresponding to a function area and a terminal area protruding from the function area as well as a first counter substrate corresponding to the function area; and
a second unit having a second terminal substrate corresponding to the function area and the terminal area as well as a second counter substrate corresponding to the function area, which are bonded to each other so that both the first unit and the second unit are positioned on opposite sides of a bonding surface.
